(19) United States
(12) Patent Application Publication
(10) Pub. No.: US 2009/0161687 A1
(43) Pub. Date: Jun. 25, 2009

(54) Medium Access Control Method for Data Transmission Through CATV Access Network

(76) Inventors: Jin Fei Yu, Beijing (CN); Zhi Gang Zhang, Beijing (CN); Junbiao Zhang, Beijing (CN)

Correspondence Address: Thomson Licensing LLC, P.O. Box 5312, Two Independence Way, PRINCETON, NJ, 08543-5312, US

(21) Appl. No.: 12/226,233

(22) PCT Filed: Apr. 10, 2007
(86) PCT No.: PCT/EP2007/053473

§ 371 Date: Oct. 10, 2008

(30) Foreign Application Priority Data
Apr. 11, 2006 (EP) 06300350.3

(51) Int. Cl. H04J 4/00; H04N 7/173

(52) U.S. Cl. 370/436; 725/109

(57) ABSTRACT

The present invention relates to a medium access control method for data communication through CATV access network over coaxial cable, wherein the method comprises transmitting downstream data frames from a central device to network terminals in downstream time slots of super frames and receiving upstream data frames from said network terminals to said central device in upstream time slots of the super frames over a same carrier frequency, said super frame being divided into multiple time slots comprising at least one downstream time slot intended for transmitting data frames, and one or more upstream time slots which are assigned respectively by said central device to said network terminals for transmitting upstream data frames, each one upstream time slot being allocable to one network terminal. Advantageously, the data is transmitted through a CATV access network over coaxial cable by using this access control method with guaranteed QoS.

### FIELD OF THE INVENTION

The present invention relates to data transmission technology, and particularly to a method for medium access control of data transmission through CATV access network over coaxial cable.

### BACKGROUND OF THE INVENTION

There are some existing specifications which define the communications and operation support interface requirements for a data over cable system. One of these specifications is Data Over Cable Service Interface Specification (DOCSIS), an international standard which permits the addition of high-speed data transfer to an existing cable TV system and is employed by many cable television operators to provide Internet access over their existing hybrid fibre coaxial (HFC) infrastructure.

However, the cable modems designed based on these solutions are very expensive. And the QoS (Quality of Service), which is vital for real time voice communication and video streaming, can not be guaranteed in these methods.

On the other hand, along with the rapid development of WiFi technology, the large expansion of the market capacity has made the implementation cost of IEEE802.11 reduced a lot for the past year. An idea of making use of the mature hardware and software implementation of IEEE802.11 protocol stacks is proposed in some of prior arts, however, none of them makes it actually workable up to the present.

Therefore, it is desirable to develop a new method in order to transmit data through CATV access network over the coaxial cable, which can guarantees the Quality of Service (QoS).

### SUMMARY OF THE INVENTION

The present invention is to develop a new medium access control method in order to provide a cost-effective and QoS guaranteed technology for data service over coaxial cable through CATV access network.

In one aspect of the present invention, a medium access control method is provided in both central device end and network terminal end for a CATV access network for data transmission through said access network which comprises one or more network terminals connected to a central device over coaxial cable. The method generally comprises transmitting downstream data frames from said central device to said network terminals in downstream time slots of super frames and receiving upstream data frames from said network terminals to said central device in upstream time slots of the super frames over a same carrier frequency in a synchronization mode. Wherein said super frame is divided into multiple time slots comprising at least one downstream time slot intended for transmitting data frames from said central device to said network terminals, and one or more upstream time slots which are respectively assigned by said central device to said network terminals for transmitting upstream data frames, each one upstream time slot being allocable to one network terminal.

Advantageously, the data frames are transmitted between said network terminals and said central device in a time divisional function through the CATV access network over the coaxial cable in synchronization mode. Therefore the services, such as voice, video and data can be transmitted over existing coaxial cables, etc., some mature hardware and software implementation can be employed in the cable access network without much changes and the system designed based on this synchronization TDF solution is thus not costly.

### BRIEF DESCRIPTION OF THE DRAWINGS

FIG. 1 illustrates a simplified exemplary TDF access network architecture according to the present invention;

FIG. 2 illustrates the 802.11 MAC sublayer in OSI reference model;

FIG. 3 illustrates the TDF transmission entity in OSI reference model according to the present invention;

FIG. 4 illustrates the communication mode entrance procedure according to the present invention;

FIG. 5 illustrates a TDF super frame structure according to one embodiment of the present invention;

FIG. 6 illustrates the registration procedure according to the present invention;

FIG. 7 illustrates the unregistration procedure according to the present invention; and

FIG. 8 illustrates the alive notification procedure according to the present invention.

### DETAILED DESCRIPTION OF THE PREFERRED EMBODIMENTS

### General Description

Application Scenario

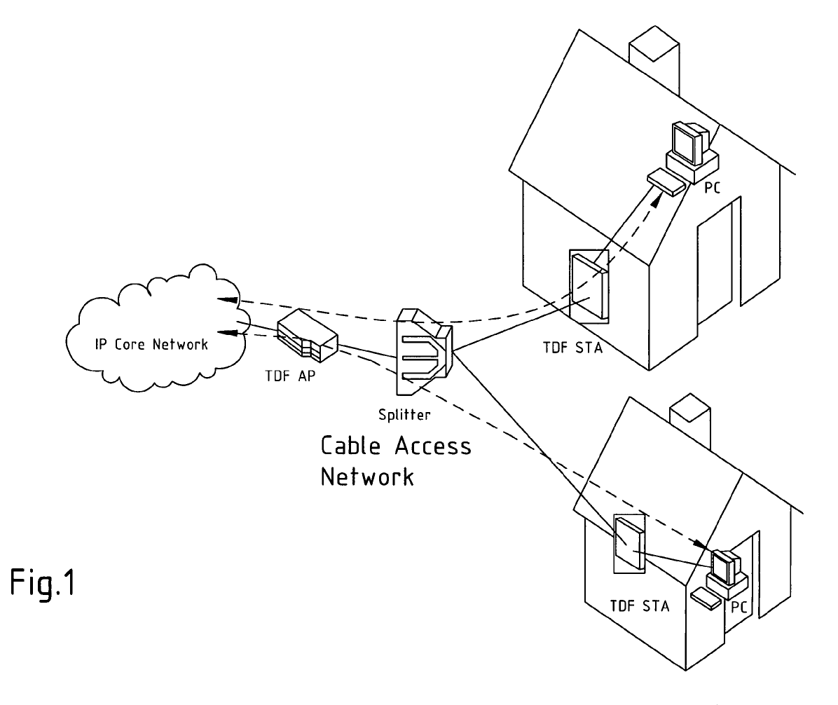

In order to provide data service over existing coaxial cable TV system (CATV), the present invention deploys a time divisional function (TDF) protocol compliant Access Point (AP) and stations (STAs) in the cable access network. The AP and STAs are connected via splitters in the hierarchical tree structure. In this way, the user at home can access the remote IP core network via the cable access network. The detailed network topology is illustrated as illustrated in FIG. 1.

As can be seen from FIG. 1, in this typical access network infrastructure, there is a TDF protocol compliant AP which has one Ethernet Interface in connection with the IP core network, and one coaxial cable interface in connection with the cable access network. On the other end of the cable access network, there are TDF protocol compliant STAs, i.e. terminals, which connect with the cable access network via the coaxial cable interface and connect with the home LAN (Local Area Network) via the Ethernet interface.

According to the invention, both TDF APs and STAs implement the protocol stack separately in logically link control sublayer, MAC sublayer and physical layer, according to 802.11 series specifications. However, in the MAC sublayer, the TDP APs and STAs replace the 802.11 frame transmission entity with TDF frame transmission entity. So, the MAC sublayer for TDF APs and STAs is composed of 802.11 frame encapsulation/decapsulation entity and TDF frame transmission entity, while MAC sublayer for 802.11 compliant APs and STAs consists of 802.11 frame encapsulation/decapsulation entity and 802.11 frame transmission entity. For an integrated AP and STA, the TDF frame transmission entity and 802.11 frame transmission entity may co-exist at the same time, to provide both 802.11 and TDF functionality. The switch between the two modes can be realized by manually or dynamically configuration.

Basic Approach

The main idea of the TDF protocol is to transmit IEEE802.11 frames in the coaxial cable media instead of over the air. The purpose of utilizing the IEEE802.11 mechanism is to make use of the mature hardware and software implementation of 802.11 protocol stacks.

The main feature of TDF is its unique medium access control method for transmitting IEEE802.11 data frames. That is, it doesn't utilize the conventional IEEE802.11 DCF (Distributed Coordination Function) or PCF (Point Coordination Function) mechanism to exchange MAC frames, which include MSDU (MAC Service Data Unit) and MMPDU (MAC Management Protocol Data Unit). Instead, it uses time division access method to transmit MAC frames. So the TDF is an access method which defines a detailed implementation of frames transmission entity located in MAC sublayer.

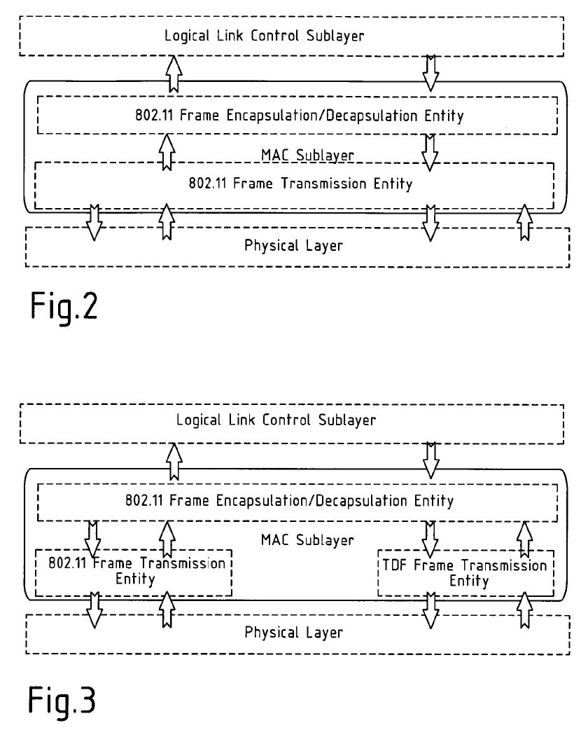

For the purpose of comparison, here we illustrate IEEE802.11 MAC sublayer protocol in the OSI reference model as shown in the FIG. 2. While the exact location for TDF protocol in the OSI reference model is illustrated in the FIG. 3.

Communication Mode Entrance Procedure

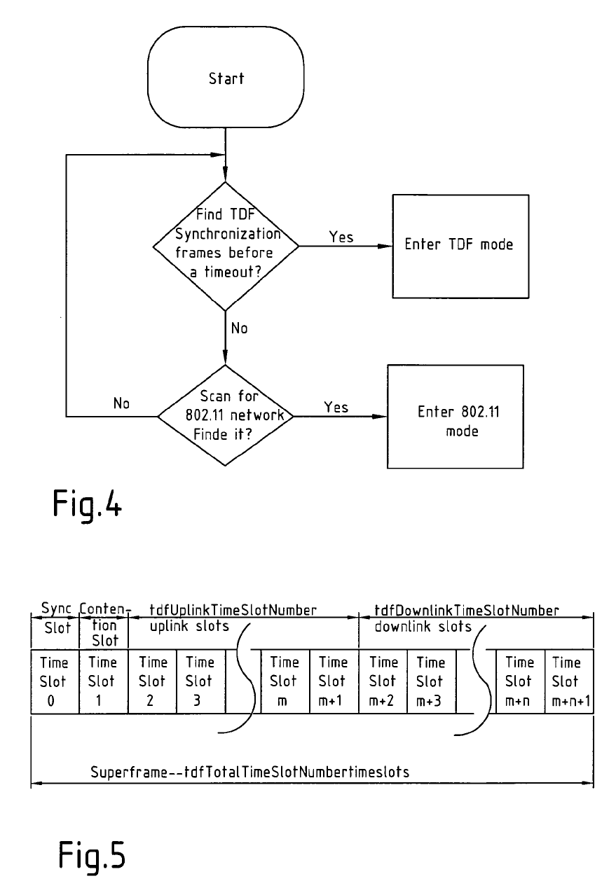

Currently, there are two communication modes proposed for the TDF compliant stations described as below. One is the standard IEEE802.11 operation mode, which obeys to the frame structure and transmission mechanism defined in IEEE802.11 series standard; the other is in TDF operation mode, the detailed information about which will be discussed in the following paragraphs. The strategy of determining entering into which operation mode when a TDF STA is started is indicated in the FIG. 4. Once a TDF STA receives a synchronization frame from an AP, it is enabled to entering into TDF mode, if there is no synchronization frame received within a preset timeout, then the TDF STA remains or shifts into IEEE802.11 mode.

### TDF Protocol Functional Description

Access Method

The physical layer in a TDF station may have multiple data transfer rate capabilities that allow implementations to perform dynamic rate switching with the objective of improving performance and device maintenance. Currently, TDF station may support three types of data rates: 54 Mbps, 18 Mbps and 6 Mbps. The data service is provided mainly in 54 Mbps data rate. When there are some problems for a station to support 54 Mbps data transmission, it may temporarily switch to 18 Mbps data rate. The 6 Mbps data rate operation mode is designed for the purpose of network maintenance and station debugging.

The data rate may be configured statically before a TDF station enters the TDF communication procedure, and remain the same during the whole communication process. On the other hand, the TDF station may also support dynamical data rate switch during the service. The criteria for the data rates switch may be based on the channel signal quality and other factors.

The fundamental access method of TDF protocol is Time Division Multiple Access (TDMA), which allows multiple users to share the same channel by dividing it into different time slots. The TDF STAs transmit in rapid succession for uplink traffic, one after the other, each using their own time slot in a TDF super frame assigned by the TDF AP. For downlink traffic, the STAs share the channels, and select the data or management frames targeting to them by comparing the destination address information in the frames with their address. FIG. 5 illustrates an example of TDF super frame structure and the time slots allocation for a typical TDF super frame when there are m STAs which simultaneously compete for the uplink transmission opportunity.

As shown in FIG. 5, there are fixed tdfTotalTimeSlotNumber timeslots per TDF super frame, which is composed of one synchronization time slot used to send clock synchronization information from TDF AP to TDF STAs; one contention time slot used to send registration request for uplink time slot allocation; tdfUplinkTimeSlotNumber uplink time slots used by the registered TDF STAs to send data and some management frames to TDF AP one after another; and tdfDownlinkTimeSlotNumber downlink time slots used by TDF AP to transmit data and registration response management frames to the modems. Except the synchronization time slot, all other time slots, which are named as common time slot, have same duration whose length equals with tdfCommonTimeSlotDuration. The value of tdfCommonTimeSlotDuration is defined to allow the transmission of at least one largest IEEE802.11 PLCP (physical layer convergence protocol) protocol data unit (PPDU) in one normal time slot for the highest data rate mode. The duration of synchronization time slot, tdfSyncTimeSlotDuration, is shorter than that of the common time slot, because the clock synchronization frame, which is transmitted from TDF AP to TDF STA in this time slot, is shorter than the 802.11 data frame.

As a result, the duration of one TDF super frame, defined as tdfSuperframeDuration, can be calculated by:

tdfSuperframeDuration=tdfSyncTimeSlotDuration+tdfCommonTimeSlotDuration*(tdfTotalTimeSlotNumber−1)

The relationship between tdfTotalTimeSlotNumber, tdfUplinkTimeSlotNumber and tdfDownlinkTimeSlotNumber satisfies the following equality:

tdfTotalTimeSlotNumber=tdfUplinkTimeSlotNumber+tdfDownlinkTimeSlotNumber+2

Furthermore, the number of allocated uplink time slots for the TDF STAs in a TDF super frame may change from one to tdfUplinkTimeSlotThreshold. Accordingly, the available downlink time slots in a TDF super frame may change from (tdfTotalTimeSlotNumber−2) to (tdfTotalTimeSlotNumber−2−tdfMaximumUplinkTimeSlotNumber). Every time when there is one TDF STA which asks for an uplink time slot, the TDF AP will deduce one or more time slots from the available downlink time slots, and then allocate these time slots to the TDF STA, as long as the uplink time slots number won't exceed tdfMaximumUplinkTimeSlotNumber after that. The value of tdfMaximumUplinkTimeSlotNumber may vary in different implementations. But it must be carefully chosen so that there is at least one downlink time slot available for an associated TDF STA in order to guarantee the QoS of data service. Furthermore, all successive time slots that will be used by the same TDF STA or AP for same direction transmission can be merged to send MAC frames continuously to avoid the wastes at the edge of these time slots caused by the unnecessary conversion and guarding.

In current implementation, the tdfCommonTimeSlotDuration is about 300 us, which is enough for the TDF STA to transmit at least one largest 802.11 PPDU in one common time slot for 54M mode, and there are total 62 time slots per TDF super frame. In these time slots, there are 20 uplink time slots and 40 downlink time slots in this way. When there are 20 STAs, each TDF STA can be guaranteed that it has access to 680 kbps uplink data rate and shares 30 Mbps (40 continuous time slots) downlink data rate; when there are 30 STAs, each TDF STA can be guaranteed that it has access to 680 kbps uplink data rate and shares 22.5 Mbps (30 continuous time slots) downlink data rate. The tdfMaximumUplinkTimeSlotNumber is 30. Finally, the value of tdfSuperframeDuration, which is the total duration of 61 common time slots and one synchronization time slot, is about 18.6 ms and it can be defined to different value for different usage. For example, if there is only 1 TDF STA, it can be guaranteed that it has 4 time slots to achieve about 18 Mbps uplink data rate and own 18 Mbps (4 continuous time slots) downlink data rate. In this way, the value of tdfSuperframeDuration, which is the total duration of nine data timeslots and one synchronization timeslot, is about 4 ms.

Frame Formats

In the 802.11 specification, three major frame types exist. Data frames are used to exchange data from station to station. Several different kinds of data frames can occur, depending on the network. Control frames are used in conjunction with data frames to perform area clearing operations, channel acquisition and carrier-sensing maintenance functions, and positive acknowledgement of received data. Control and data frames work in conjunction to deliver data reliably from station to station. More specifically, one important feature for the data frames exchanging is that there is an acknowledgement mechanism, and accordingly an Acknowledgement (ACK) frame for every downlink unicast frame, in order to reduce the possibility of data loss caused by the unreliable wireless channel. Finally, management frames perform supervisory functions: they are used to join and leave wireless networks and move associations from access point to access point.

However, in TDF system, because TDF STAs passively waits for the Synchronization frame from TDF AP to find the targeting TDF AP, there is no need for the classical Probe Request and Probe Response frames. Furthermore, the frames are exchanged in coaxial cable instead of in the air, so it isn't necessary to define RTS and CTS frames to clear an area and prevent the hidden node problem, and to define ACKs frames to ensure the reliability of delivery of data frames.

So, in TDF protocol, we only use some useful 802.11 MSDU and MMPDU types for data over coaxial cable scenario. For example, we utilize the data subtype in data frame types, which is used to encapsulate the upper layer data and transmit it from one station to another. Furthermore, to cope with clock synchronization requirement in TDF system, we define a new kind of management frame-Synchronization frame; and to realize the functionality of uplink time slot request, allocation and release, we defines other four kinds of management frames that are Registration request, Registration response, Unregistration request and Alive notification.

To summarize it, we have defined four new subtypes in management frame type in TDF protocol. The following table defines the valid combinations of type and subtype added in TDF protocol. Table 1 shows valid type and subtype for TDF frames added in TDF protocol.

TABLE 1

| Type description | Subtype description |
|---|---|
| Management | Synchronization |
| Management | Registration request |
| Management | Registration response |
| Management | Unregistration request |
| Management | Alive notification |

### TDF Access Procedure

TDF AP Finding and Clock Synchronization Procedure

TDF protocol depends a great deal on the distribution of timing information to all the nodes. Firstly, the TDF STA listens to a Synchronization frame to decide if there is a TDF AP available. Once it enters the TDF communication procedure, it uses the Synchronization frame to adapt the local timer, based on which the TDF STA shall decide if it is its turn to send the uplink frames. At anytime, TDF AP is master and TDF STA is slave in synchronization procedure. Further, if it hasn't received any Synchronization frame from the associated AP for a predefined threshold period, which is defined as tdfSynchronizationCycle, the TDF STA will think that the AP has quit the service, and then it will stop the TDF communication process and start to look for any TDF AP by listening to the Synchronization frame again.

In the TDF system, all STAs associated with the same TDF AP shall be synchronized to a common clock. The TDF AP shall periodically transmit special frames called Synchronization that contains its clock information to synchronize the modems in its local network. Every TDF STA shall maintain a local timing synchronization function (TSF) timers, to ensure it is synchronized with the associated TDF AP. After receiving a Synchronization frame, a TDF STA shall always accept the timing information in the frame. If its TSF timer is different from the timestamp in the received Synchronization frame, the receiving TDF STA shall set its local timer according to the received timestamp value. Further, it may add a small offset to the received timing value to account for local processing by the transceiver.

Synchronization frames shall be generated for transmission by the TDF AP once every TDF super frame time units and sent in the Sync time slot of every TDF super frame.

Registration Procedure

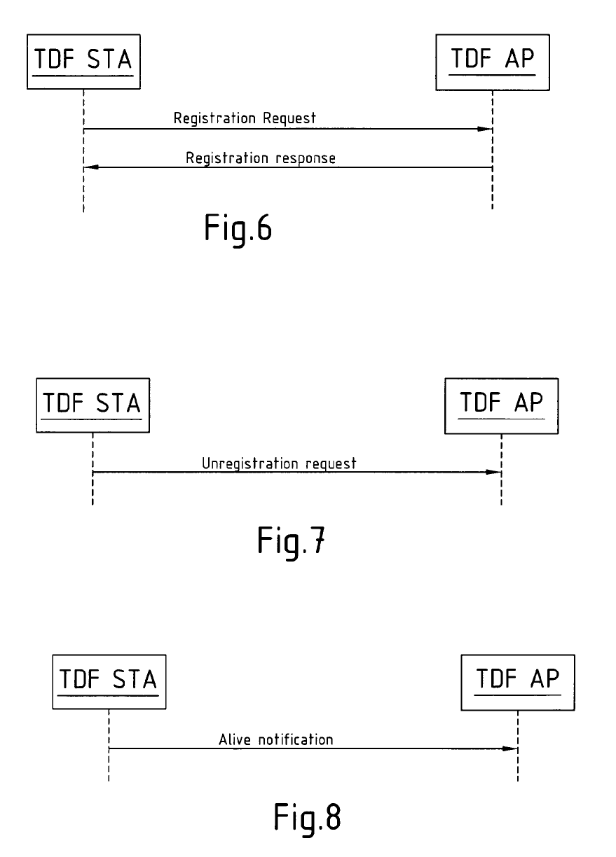

FIG. 6 illustratively describes the whole procedure of registration. Once a TDF STA has acquired timer synchronization information from the Synchronization frame, it will learn when time slot 0 starts. If a TDF STA doesn't associate with any TDF AP, it will try to register with the specific TDF AP, which sent the Synchronization frame, by sending Registration request frames to TDF AP during the contention time slot, which is the second time slot in a TDF super frame. The duration of contention time slot, which equals with tdfCommonTimeSlotDuration, and the Registration request frame structure should be carefully designed to allow for sending at least tdfMaximumUplinkTimeSlotNumber Registration request frames in one contention time slot. Based on the design, the contention time slot is divided into tdfMaximumUplinkTimeSlotNumber same length sub-timeslots.

As soon as it finds the targeting TDF AP, a TDF STA will choose one sub-timeslot in the contention time slot to send Registration request frame to the TDF AP according to the following method:

Every time when it is allocated an uplink time slot, a TDF STA will store the allocated uplink time slot number, defined as tdfAllocatedUplinkTimeSlot, which indicates the time slots' location in the whole uplink time slots pool and ranges from 1 to tdfMaximumUplinkTimeSlotNumber.

The TDF AP should try its best to allocate same uplink time slot to the same TDF STA every time when it asks for an uplink time slot.

When it is time to decide to choose which sub-timeslot to send Registration request frame, if there is a stored tdfAllocatedUplinkTimeSlot value, the TDF STA will set the sub-timeslot number as same as tdfAllocatedUplinkTimeSlot; if there isn't such a value, the TDF STA will randomly choose one sub-timeslot in the tdfMaximumUplinkTimeSlotNumber available sub-timeslots. It will send the Registration request frame to the TDF AP in the randomly chosen sub-timeslot.

The purpose for this kind of operation is to reduce the chance of collision when there are many STAs start at the same time and try to register with the same TDF AP simultaneously.

The TDF STA will list all data rates it supports at that time and also carry some useful information such as the received signal Carrier/Noise ratio in the Registration request frame. It may send several successive Registration request frames with different supported data rates, starting from the highest data rate. After sending out the frame, the TDF STA will listen for the Registration response frames from the TDF AP.

After receiving a Registration request frame from a TDF STA, based on the following method, the TDF AP will send different kinds of Registration response frames back to the TDF STA in the downlink time slots:

If the already allocated uplink time slots equals with tdfMaximumUplinkTimeSlotNumber, the TDF AP will put an uplinkTimeSlotUnavailable indicator in the frame body.

If the TDF AP doesn't support any data rates listed in the supportedDataratesSet in the Registration request management frame, the TDF AP will put an unsupportedDatarates indicator in the frame body.

If there are uplink timeslots available to allocate and common data rates that both the TDF AP and TDF STA can support, the AP will allocate one uplink time slot and choose a suitable common data rates according to some information such as Carrier/Noise ratio in the STA's Registration request frame, and then send a Registration response frame to the TDF STA. In the frame body, the information about the allocated uplink time slot and the chosen data rate will be contained.

After a successful registration process, the TDF STA and TDF AP will reach an agreement on which uplink time slot and data rate to use.

Fragmentation/Defragmentation Procedure

In TDF protocol, the time slot duration for the transmission of MSDU is fixed as tdfCommonTimeSlotDuration. In some data rates, when the MSDU's length is more than a threshold, it is impossible to transmit it in a single time slot. So when a data frame for uplink transmission is longer than the threshold, which is defined as tdfFragmentationThreshold and varies depending on different data rates, it shall be fragmented before scheduled for transmitting. The length of a fragment frame shall be an equal number of octets (tdfFragmentationThreshold octets), for all fragments except the last, which may be smaller. After fragmentation, the fragmented frames shall be put into the outgoing queue for transmission to the TDF AP. This fragmentation procedure may run in the TDF frame transmission entity or in the upper layer by using the tdfFragmentationThreshold dynamically set in the TDF frame transmission entity.

At the TDF AP end, each fragment received contains information to allow the complete frame to be reassembled from its constituent fragments. The header of each fragment contains the following information that is used by the TDF AP to reassemble the frame:

Frame type

Address of the sender, obtained from the Address 2 field

Destination address

Sequence Control field: This field allows the TDF AP to check that all incoming fragments belong to the same MSDU, and the sequence in which the fragments should be reassembled. The sequence number within the Sequence Control field remains the same for all fragments of a MSDU, while the fragment number within the Sequence Control field increments for each fragment.

More Fragments indicator: Indicates to TDF AP that this is not the last fragment of the data frame. Only the last or sole fragment of the MSDU shall have this bit set to zero. All other fragments of the MSDU shall have this bit set to one.

The TDF AP shall reconstruct the MSDU by combining the fragments in order of fragment number subfield of the Sequence Control field. If the fragment with the More Fragments bit set to zero has not yet been received, the TDF AP will know that the frame is not yet complete. As soon as the TDF AP receives the fragment with the More Fragments bit set to zero, it knows that no more fragments may be received for the frame.

The TDF AP shall maintain a Receive Timer for each frame being received. There is also an attribute, tdfMaxReceiveLifetime, which specifies the maximum amount of time allowed to receive a frame. The receive timer starts on the reception of the first fragment of the MSDU. If the receive frame timer exceeds tdfMaxReceiveLifetime, then all received fragments of this MSDU are discarded by the TDF AP. If additional fragments of a directed MSDU are received after its tdfMaxReceiveLifetime is exceeded, those fragments shall be discarded.

### Uplink Transmission Procedure

After receiving the Registration response frame from the TDF AP, the TDF STA will analyze the frame body to see if it is granted an uplink time slot. If not, it will stop for a while and apply for the uplink time slot later. If yes, it will start to transmit uplink traffic during the assigned time slot using the data rate indicated in the Registration response frame.

At the beginning of the uplink transmission during the assigned timeslot, the TDF STA will send the first frame in its outgoing queue to the TDF AP if there is at least one outgoing frame in the queue. After that, the TDF STA will check the second uplink frame's length and evaluate if it is possible to send it during the remaining duration in the assigned timeslot. If not, it will stop the uplink transmission procedure and wait for sending it in the assigned timeslot during the next TDF super frame. If yes, it will immediately send the second frame to the destination TDF AP. The sending procedure will continue to run in this way until the assigned timeslot has ended, or there isn't any uplink frame to transmit.

Downlink Transmission Procedure

In the whole TDF communication procedure, the total downlink time slots number may change dynamically due to the changing associated STAs number. When the TDF AP prepares to send frames to the associated STAs, it will compare the time left in the remaining downlink time slots with the duration needed for transmitting the specific downlink frame using the agreed data rate. Then based on the result, it will decide if the frame should be transmitted with the specific data rate during this TDF super frame. Furthermore, TDF AP doesn't need to fragment any downlink frames.

When it isn't time for the associated STA to send uplink traffic, the STA will always listen to the channel for the possible downlink frames targeting to it.

Unregistration Procedure

As shown in FIG. 7, if the TDF STA decides to quit the TDF communication procedure, it shall send an Unregistration request frame to the associated TDF AP during its uplink time slot, in order to inform the TDF AP to release the allocated uplink time slot resource for it. After receiving the Unregistration request frame, the TDF AP will free the uplink time slot assigned for the TDF STA and put it into free time slots pool for the future use.

Alive Notification Procedure

Now with reference to FIG. 8, to release the resources as soon as possible when a TDF STA unexpectedly crashes or shuts down, the TDF STA must report its aliveness by sending an Alive notification frame periodically to TDF AP during its uplink time slot period. If there isn't any Alive notification frame for a predefined threshold period which is named as tdfAliveNotificationCycle, the associated TDF AP will think that the TDF STA has quit the service, and then release the uplink time slot allocated for the TDF STA, just like receiving an Unregistration request frame from the TDF STA.

In order to ensure coexistence and interoperability on multirate-capable TDF STAs, this specification defines a set of rules that shall be followed by all stations:

The Synchronization frames shall be transmitted at the lowest rate in the TDF basic rate set so that they will be understood by all STAs.

All frames with destination unicast address shall be sent on the supported data rate selected by the registration mechanism. No station shall transmit a unicast frame at a rate that is not supported by the receiver station.

All frames with destination multicast address shall be transmitted at the highest rate in the TDF basic rate set.

Whilst there has been described in the forgoing description preferred embodiments and aspects of the present invention, it will be understood by those skilled in the art that many variations in details of design or construction may be made without departing from the present invention. The present invention extends to all features disclosed both individually, and in all possible permutations and combinations.

1. A medium access control method in a central device for an access network which comprises one or more network terminals connected to said central device over a communication medium, the method comprising steps of
transmitting downstream data frames from said central device to said network terminals in downstream time slots of super frames over a carrier frequency, and
receiving upstream data frames from said network terminals in upstream time slots of the super frames over the same carrier frequency,
wherein said central device is connected to said one or more network terminals over a wired communication medium, the method further comprising a step of
allocating upstream time slots to respective network terminals, whereby said central device receives the upstream data frames from said network terminals in respective allocated upstream time slots of said super frames, wherein
said super frame is divided into multiple time slots comprising at least one downstream time slot for transmitting data frames from said central device to said network terminals, wherein a downstream time slot is shared for transmission to a plurality of network terminals, and one or more upstream time slots which are respectively assigned by said central device to said network terminals for transmitting upstream data frames, each upstream time slot being allocated to a single network terminal.

2. The medium access control method as claimed in claim 1, further comprising a step of
transmitting a synchronization frame from said central device to said network terminals in a synchronization time slot in each one of said super frames in order to periodically send the synchronization information that enables said network terminals to be synchronized with the time of said central device.

3. The medium access control method as claimed in claim 1, further comprises a step of
receiving registration requests from said network terminals for allocating upstream time slots in a contention time slot in each one of said super frames.

4. The medium access control method as claimed in claim 3, wherein said central device receives said registration request from said network terminals for allocating upstream time slots in respective sub-timeslots in said contention time slot.

5. The medium access control method as claimed in claim 4, wherein said contention time slot is divided into a preset number of sub-timeslots with equal length of duration.

6. The medium access control method as claimed in claim 4, wherein said central device receives the registration request from said network terminal in a randomly selected sub-timeslot of the contention time slot, when there is no previously allocated upstream time slot for said network terminal; or else, said central device receives the registration request in a sub-timeslot with a same sequence number value of a previously allocated upstream time slot for said network terminal.

7. The medium access control method as claimed in claim 1, further comprising the method further comprises a step of
transmitting registration responses from said central device to said network terminals in response to registration requests received from said network terminals.

8. The medium access control method as claimed in claim 1, further comprising a step of
releasing an allocated upstream time slot for a network terminal in response to an un-registration request received from said network terminal.

9. The medium access control method as claimed in claim 1, further comprising a step of
releasing an allocated upstream time slot for a network terminal in case there is no alive notification received from said network terminal for a time that is longer than a predefined threshold.

10. A medium access control method in a network terminal of an access network which comprises one or more network terminals connected to a central device over a communication medium, the method comprising steps of
receiving downstream data frames from said central device to said network terminal in downstream time slots of super frames over a carrier frequency, and
transmitting upstream data frames from said network terminal in upstream time slots of the super frames over the same carrier frequency,
wherein said network terminal is connected to said central device over a wired communication medium, the method further comprising a step of
allocating one dedicated upstream time slot in each one of the super frames for said network terminal for transmitting the upstream data frames, whereby said network terminal transmits the upstream data frames in said dedicated upstream time slots of said super frames, wherein
said super frame is divided into multiple time slots comprising at least one downstream time slot for transmitting data frames from said central device to said network terminal, wherein a downstream time slot is shared for transmission to a plurality of network terminals, and one or more upstream time slots which are assigned respectively by said central device to said network terminals for transmitting upstream data frames, each upstream time slot being allocated to a single network terminal.

11. The medium access control method as claimed in claim 10, further comprising a step of
receiving a synchronization frame from said central device to said network terminal in a synchronization time slot in each one of said super frames so as to initiate a synchronization time division mode communication with said central device, and to periodically synchronizes with the time of said central device in response to the received synchronization information.

12. The medium access control method as claimed in claim 11, further comprising a step of
transmitting a registration request from said network terminal to said central device in response to a received synchronization frame in order to allocate one dedicated upstream time slot in each one of said super frames for said network terminal in a contention time slot in each one of said super frames.

13. The medium access control method as claimed in claim 12, wherein said network terminals send said registration requests for allocating said upstream time slots to said central device in respective sub-timeslots in said contention time slot.

14. The medium access control method as claimed in claim 13, wherein said contention time slot is divided into a preset number of sub-timeslots with equal length of duration.

15. The medium access control method as claimed in claim 13, wherein said network terminal sends the registration request to said central device in a randomly selected sub-timeslot of the contention time slot, when there is no previously allocated upstream time slot for said network terminal; or else, said network terminal sends the registration request in a sub-timeslot with a same sequence number value of a previously allocated upstream time slot for said network terminal.

16. The medium access control method as claimed in claim 10, further comprising a step of
receiving registration responses from said central device in response to the registration request transmitted from said network terminal.

17. The medium access control method as claimed in claim 10, further comprising a step of
transmitting an un-registration request to said central device for releasing allocated upstream time slot for said network terminal, when the network terminal decides to quit from the current communication mode with said central device.

18. The medium access control method as claimed in claim 10, further comprising a step of
transmitting an alive notification to said central device periodically in order to maintain the current communication mode with said central device.
